(19) United States
(12) Patent Application Publication
(10) Pub. No.: US 2016/0081274 A1
(43) Pub. Date: Mar. 24, 2016

(54) Berry Picking Systems

(71) Applicant: West O. Haynes, Medical Lake, WA (US)

(72) Inventor: West O. Haynes, Medical Lake, WA (US)

(21) Appl. No.: 14/491,343

(22) Filed: Sep. 19, 2014

(51) Int. Cl. A01D 46/22

(52) U.S. Cl. CPC A01D 46/22

(57) ABSTRACT

A berry picking tool comprises a plurality of tines separated by a gap having a width to harvest berries without inflicting damage to berry bushes. The tines arranged between first and second dive rails suitable for interfacing with leaves and branches of the berry bushes without stripping the leaves and/or the branches from the berry bushes.

### BACKGROUND

Berry picker tools may be utilized to pick large amounts of berries. Existing berry picker tools may strip the leaves and/or the branches from the berry bushes. Stripping the leaves and/or the branches from the berry bush greatly damages the berry bush and decreases future berry production. Moreover, stripping the leaves and the branches from the berry bush is illegal.

Accordingly there remains a need in the art for improved berry picker tools and methods of picking berries that reduce the amount of damage inflicted on berry bushes while increasing the amount of harvested berries.

### BRIEF DESCRIPTION OF THE DRAWINGS

The detailed description is described with reference to the accompanying figures. The use of the same reference numbers in different figures indicates similar or identical items.

FIG. 1A illustrates an example berry picking tool.

FIG. 1B is a perspective bottom view of the example berry picking tool of FIG. 1A.

FIG. 2 illustrates an example berry cleaning system including a cleaning table.

FIG. 3 is a top view of the cleaning table of FIG. 2.

### DETAILED DESCRIPTION

### Overview

This disclosure is directed to berry picking tools and berry picking kits. The berry picking tools may have a plurality of tines. Each of the plurality of tines may be separated by a gap having a width of ¼ inch to harvest about 90% of berries without inflicting damage to berry bushes. The tines may be substantially cylindrical tines arranged between first and second dive rails suitable for interfacing with leaves and branches of berry bushes without stripping the leaves and/or the branches from the berry bushes. The berries may be huckleberries, blueberries, bilberries, whortleberries, blackberries, thimbleberries, raspberries, etc.

In one embodiment, the berry picking tool may comprise a plurality of substantially cylindrical tines arranged along a perimeter of a planar bottom surface and between first and second dive rails. Each tine of the plurality of tines may be separated by a gap having a width of ¼ inch. The plurality of tines may be formed of metal and may have an outside diameter of ⅛ inch and a length of about 7 inches. The plurality of tines may be flexible to provide for deforming around branches of a berry bush as a result of the berry picking tool interfacing with the berry bush. For example, the plurality of tines may flex around branches of the berry bush as the berry picking tool passes through at least a portion of the berry bush. Because the plurality of tines flex around the branches and are separated by a gap having a width of ¼ inch, the plurality of tines harvest about 90% of the berries without inflicting damage to the berry bush.

In another embodiment, the berry picking tool may comprise a first dive rail having an outside surface substantially flush with an outside surface of a first side wall and a second dive rail having an outside surface substantially flush with an outside surface of a second side wall. The outside surface of the first dive rail may be substantially flush with the outside surface of the first side wall and may be arranged 4 inches from the outside surface of the second dive rail substantially flush with the outside surface of the second side wall. The outside surface of the first dive rail substantially flush with the outside surface of the first side wall arranged 4 inches from the outside surface of the second dive rail substantially flush with the outside surface of the second side wall may define a width of a receptacle for containing harvested berries, and the receptacle and the first and second dive rails may have a combined length of four times greater than a width of the receptacle. For example, the receptacle and the dive rails may have a combined length of about 16 inches and the width of the receptacle may be about 4 inches. Because the combined length of the receptacle and the first and second dive rails is four times greater than a width of the receptacle, the dive rails displace branches arranged just outside of the width of the receptacle in order to harvest berries form about a 4 inch swath of branches. Because the berry picking tool harvests berries from a 4 inch strip of branches, the plurality of tines flex around the branches without inflicting damage to the berry bush.

In another embodiment, the berry picking kits may comprise the berry picking tool and a cleaning table. The cleaning table may have a frame and a fabric removeably coupleable to the frame. The frame may include a strainer to strain harvested berries.

While the foregoing embodiments of berry picking tools have been described, these are merely examples of berry picking tools that can be used and other berry picking tools may also be used.

### Example Berry Picking Tools

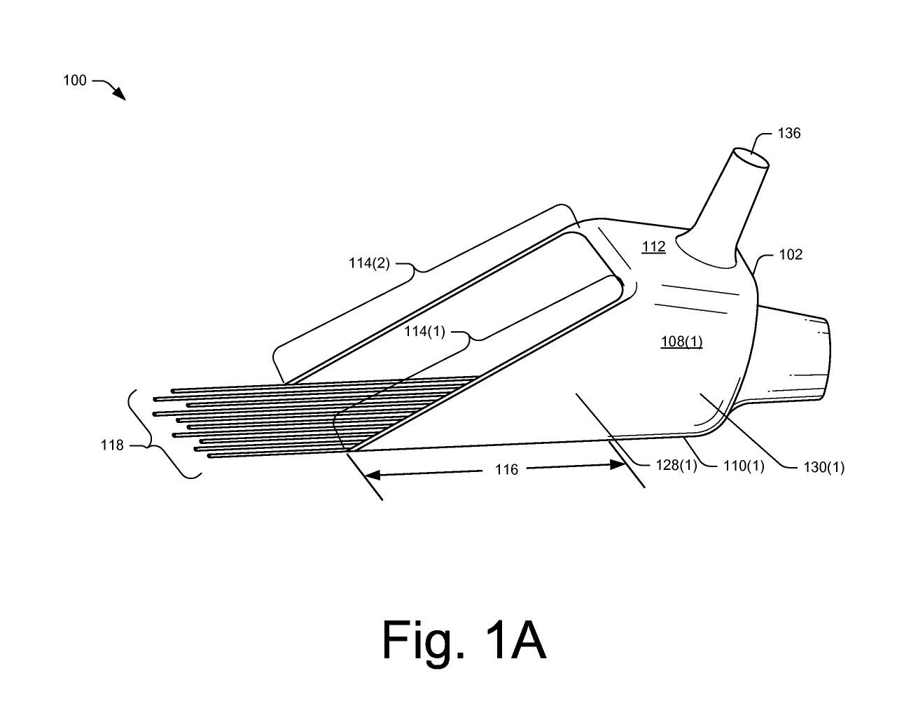

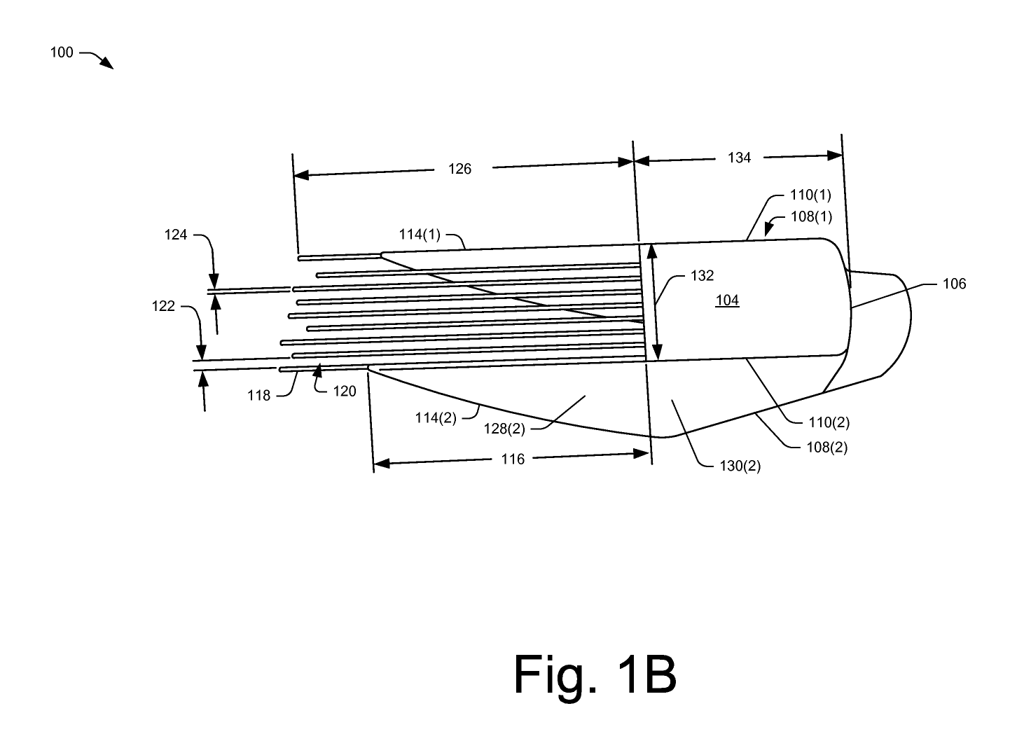

FIG. 1A illustrates an example berry picking tool 100 including a receptacle 102 for containing harvested berries. FIG. 1B is a perspective bottom view of the example berry picking tool 100 of FIG. 1A. FIG. 1B illustrates the receptacle 102 may have a planar bottom surface 104 defining a perimeter 106. The receptacle 102 having a first side wall 108(1) arranged along a first portion 110(1) of the perimeter 106 and a second side wall 108(2) arranged along a second portion 110(2) of the perimeter 106 opposite the first side wall 108(1). FIG. 1A illustrates the receptacle 102 may have a curvilinear top surface 112 arranged above at least a portion of the planar bottom surface 104 and fixed to the first and second side walls 108(1) and 108(2). A first dive rail 114(1) may extend a distance 116 from the perimeter 106 of the planar bottom surface 104. A second dive rail 114(2) may extend the distance 116 from the perimeter 106 of the planar bottom surface 104. For example, the first and second dive rails 114(1) and 114(2) may extend a distance of 7 ½ inches from the perimeter 106 of the planar bottom surface 104.

A plurality of tines 118 may be arranged along the perimeter 106 of the planar bottom surface 104 between the first and second dive rails 114(1) and 114(2). Each tine of the plurality of tines 118 may be separated by a gap 120. Each gap 120 may have a width 122 of at least about 3/16 of an inch to at most about 5/16 of an inch. In one example, the width 122 may be ¼ of an inch. Each tine of the plurality of tines 118 may be substantially cylindrical. For example, each tine of the plurality of tines 118 may have a substantially cylindrical cross sectional shape. Each tine of the plurality of tines may have an outside diameter 124 of at least about 3/32 of an inch to at most about 5/32 of an inch. In one example, the outside diameter 124 may be ⅛ of an inch. Because each tine of the plurality of tines 118 is separated by the gap 120, the plurality of tines 118 harvest an average sized berry having an averaged outside diameter of about ⅓ of an inch. For example, the berries may be huckleberries of either the Vaccinium or Gaylussacia genera in the Ericaceae family that have an average outside diameter of ⅓ of an inch.

Each tine of the plurality of tines 118 may extend a distance 126 from the perimeter 106 of the planar bottom surface 104. While FIGS. 1A and 1B illustrate each tine of the plurality of tines extending a distance 126 from the perimeter 106 of the planar bottom surface 104 greater than the distance 116 the first and second dive rails extend from the perimeter of the planar bottom surface, each tine of the plurality tines may extend a distance less than the distance 116 the first and second dive rails extend from the perimeter 106 of the planar bottom surface 104. Moreover, while FIGS. 1A and 1B illustrate the plurality of tines extending from the perimeter 106 of the planar bottom surface 104 in a staggered pattern, the plurality of tines may extend from the perimeter 106 of the planar bottom surface 104 in a non-staggered pattern. In one example, each tine of the plurality of tines 118 may extend a distance of 6 ½ inches from the perimeter 106 of the planar bottom surface 104.

In one example, the first and second dive rails 114(1) and 114(2) may extend a distance of 7 1/2 inches from the perimeter 106 of the planar bottom surface 104. The first dive rail 114(1) may have an outside surface 128(1) substantially flush with an outside surface 130(1) of the first side wall 108(1). The second dive rail 114(2) may have an outside surface 128(2) substantially flush with an outside surface 130(2) of the second side wall 108(2). The outside surface 128(1) of the first dive rail 114(1) substantially flush with the outside surface 130(1) of the first side wall 108(1) may be arranged at least about 3 inches from the outside surface 128(2) of the second dive rail 114(2) substantially flush with the outside surface 130(2) of the second side wall 108(2) and up to at most about 5 inches from the outside surface 128(2) of the second dive rail 114(2) substantially flush with the outside surface 130(2) of the second side wall 108(2) and up to at most about 5 inches. In one example, outside surface 128(1) of the first dive rail 114(1) substantially flush with the outside surface 130(1) of the first side wall 108(1) may be arranged 4 inches from the outside surface 128(2) of the second dive rail 114(2) substantially flush with the outside surface 130(2) of the second side wall 108(2). The outside surface 128(1) of the first dive rail 114(1) substantially flush with the outside surface 130(1) of the first side wall 108(1) arranged the distance from the outside surface 128(2) of the second dive rail 114(2) substantially flush with the outside surface 130(2) of the second side wall 108(2) may define a width 132 of the receptacle 102. Moreover, the receptacle 102 and the first and second dive rails 114(1) and 114(2) may have a combined length of four times greater than the width 132 of the receptacle 102. For example, the receptacle 102 and the dive rails 114(1) and 114(2) may have a combined length of about 16 inches and the width 132 of the receptacle 102 may be 4 inches. Because the combined length of the receptacle and the first and second dive rails is about four times greater than the width 132 of the receptacle 102, the dive rails 114(1) and 114(2) may displace branches arranged just outside of the width 132 of the receptacle 102 in order to harvest berries from about a 4 inch swath of branches. The receptacle 102 may have a length 134 of at least about 7 inches to at most about 10 inches. In one example, the receptacle 102 may have a length 134 of 8 ½ inches.

The receptacle 102 and the first and second dive rails 114(1) and 114(2) may be formed of a single unit of material. For example the receptacle 102 and the first and second dive rails 114(1) and 114(2) may be molded as a single unit of plastic. In another example, the first and second dive rails 114(1) and 114(2) may be formed of a metal (e.g., aluminum, steel, copper, titanium etc.). In another embodiment, the first and second dive rails 114(1) and 114(2) may be removeably coupled to the receptacle 102. The coupling mechanism 136 may provide for removeably coupling with a handle (not shown). A coupling mechanism 136 may fixed to the curvilinear top surface 112 of the receptacle 102.

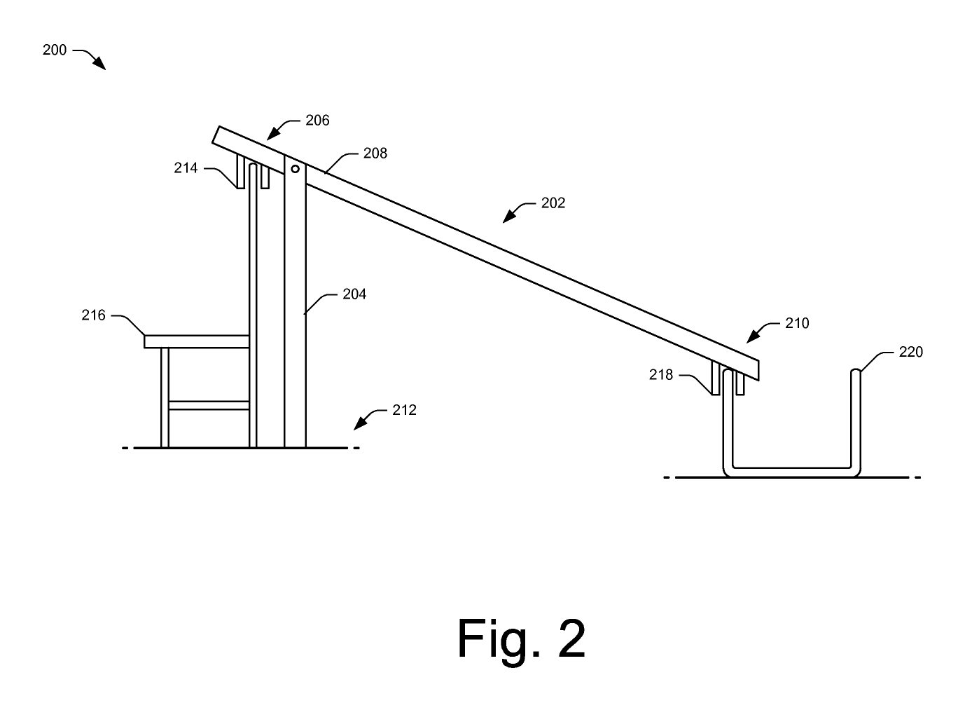

FIG. 2 illustrates an example berry cleaning system 200 including a cleaning table 202. FIG. 2 illustrates the table 202 may include a support structure 204 coupled closer to a back 206 of a frame 208 than to a front 210 of the frame 208 for supporting the back 206 of the frame 208 above a ground surface 212. In another example, the table 202 may include a coupling mechanism 214 for removeably coupling to a chair 216. The table 202 may include a coupling mechanism 218 for removeably coupling to a container 220 (e.g., a cooler, a bucket, a bin, etc.) for containing harvested berries. In some embodiments, the berry cleaning system 200 may include one or more of the berry picking tools 100. For example, the berry cleaning system 200 may include the berry picking tool 100 to harvest berries to be subsequently cleaned using the berry cleaning system 200. The berry cleaning system 200 including at least one berry picking tool 100 may define a berry picking kit.

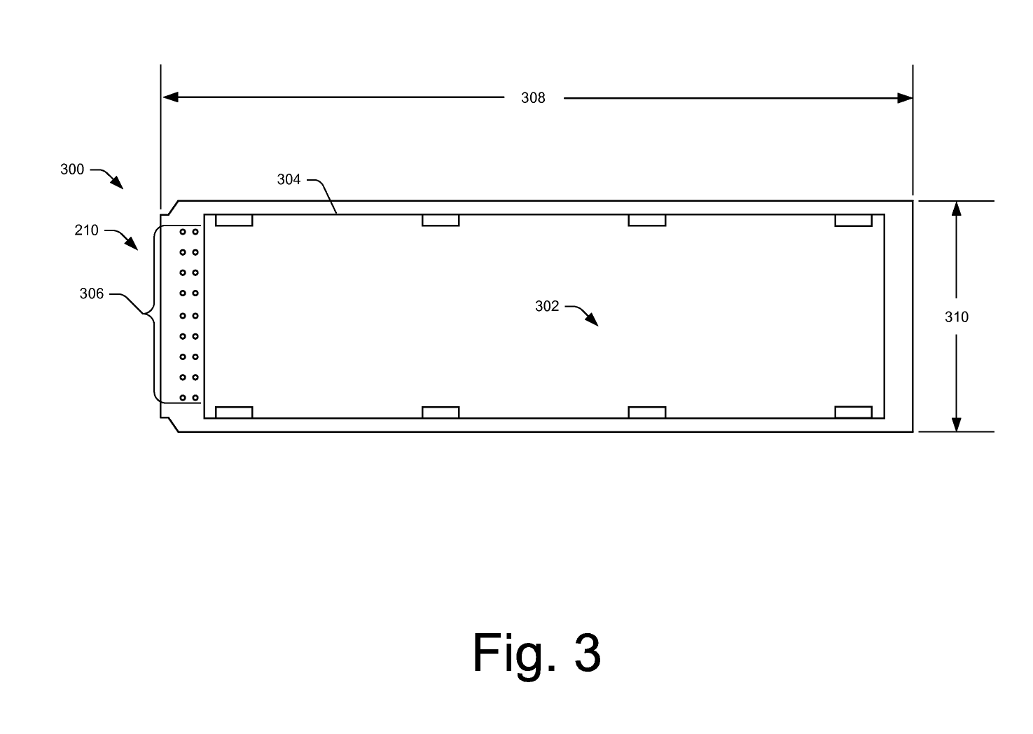

FIG. 3 is a top view 300 of the cleaning table 202 of FIG. 2. FIG. 3 illustrates the cleaning table 202 may include a fabric 302 removeably coupled on an inside 304 of the frame 208. For example, the cleaning table 202 may include a flannel fabric removeably coupled on the inside of the frame 208 that removes debris from the harvested berries. The front 210 of the frame 208 may include a strainer 306 to strain harvested berries before the harvested berries are contained in the container 220. The frame 208 may have a length 308 of at least about 26 inches up to at most about 46 inches, and a width 310 of at least about 8 inches up to at most about 28 inches. In one example, the frame may have a length of 36 inches and a width of 18 inches. The frame 208 may be formed of plastic, metal, wood, and/or composite (e.g., fiberglass, carbon fiber).

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A berry picking tool comprising:
a receptacle for containing harvested berries, the receptacle comprising:
a planar bottom surface defining a perimeter and having a first side wall arranged along a first portion of the perimeter and a second side wall arranged along a second portion of the perimeter opposite the first side wall; and
a curvilinear top surface arranged above at least a portion of the planar bottom surface and fixed to the first and second side walls;
a first dive rail extending a distance from the perimeter of the planar bottom surface;
a second dive rail extending the distance from the perimeter of the planar bottom surface; and
a plurality of substantially cylindrical tines arranged along the perimeter of the planar bottom surface between the first and second dive rails, wherein each tine of the plurality of tines is separated by a gap having a width of approximately ¼ inch.

2. The berry picking tool of claim 1, wherein each tine of the plurality of tines extends a distance from the perimeter of the planar bottom surface less than the distance the first dive rail and the second dive rail extend from the perimeter of the planar bottom surface.

3. The berry picking tool of claim 2, wherein each tine of the plurality of tines extends a distance of 6 ½ inches from the perimeter of the planar bottom surface.

4. The berry picking tool of claim 2, wherein the first and second dive rails extend a distance of 7 ½ inches from the perimeter of the planar bottom surface.

5. The berry picking tool of claim 1, wherein each tine of the plurality of tines has an outside diameter of ⅛ inch.

6. The berry picking tool of claim 1, wherein each tine of the plurality of tines comprises metal, plastic or wood.

7. The berry picking tool of claim 1, wherein each tine of the plurality of tines comprises stainless steel.

8. A device for picking berries, the device comprising:
a receptacle for containing harvested berries, the receptacle comprising:
a planar bottom surface defining a perimeter and having a first side wall arranged along a first portion of the perimeter and a second side wall arranged along a second portion of the perimeter opposite the first side wall; and
a curvilinear top surface arranged above at least a portion of the planar bottom surface and fixed to the first and second side walls;
a first dive rail having an outside surface substantially flush with an outside surface of the first side wall and protruding from the perimeter of the planar bottom surface;
a second dive rail having an outside surface substantially flush with an outside surface of the second side wall and protruding from the perimeter of the planar bottom surface;
a plurality tines arranged along the perimeter of the planar bottom surface between the first and second dive rails; and
wherein the outside surface of the first dive rail substantially flush with the outside surface of the first side wall is arranged 4 inches from the outside surface of the second dive rail substantially flush with the outside surface of the second side wall.

9. The device of claim 8, wherein a distance between the first dive rail and the second dive rail defines a width of the receptacle, and
wherein the receptacle and the first and second dive rails have a combined length of four times greater than the width of the receptacle.

10. The device of claim 9, wherein the receptacle has a length of 8 ½ inches.

11. The device of claim 9, wherein each of the first and second dive rails has a length of 7 ½ inches.

12. The device of claim 8, further comprising a coupling mechanism fixed to the curvilinear top surface, the coupling mechanism to removeably couple with a handle.

13. The device of claim 8, wherein the receptacle and the first and second dive rails are formed of a single unit of material.

14. The device of claim 13, wherein the material comprises plastic or metal.

15. The device of claim 8, wherein the first and second dive rails are removeably coupled to the receptacle.

16. A berry picking kit comprising:
a receptacle comprising:
a planar bottom surface defining a perimeter;
a first side wall arranged along a first portion of the perimeter;
a second side wall arranged along a second portion of the perimeter opposite the first side wall;
a curvilinear top surface arranged above at least a portion of the planar bottom surface and fixed to the first and second side walls;
a first dive rail extending a distance from the perimeter of the planar bottom surface;
a second dive rail extending the distance from the perimeter of the planar bottom surface;
a plurality of substantially cylindrical tines arranged along the perimeter of the planar bottom surface between the first and second dive rails, wherein each tine of the plurality of tines is separated by gap having a width of ¼ inches; and
a cleaning table comprising:
a frame having front a back and two sides, the front of the frame including a strainer to strain harvested berries; and
a fabric removeably coupleable on an inside of the frame to remove debris from the harvested berries.

17. The berry picking kit of claim 16, wherein the cleaning table further comprises a support structure coupled closer to the back of the frame than to the front of the frame for supporting the back of the frame above a ground surface.

18. The berry picking kit of claim 16, wherein the cleaning table further comprises a coupling member fixed closer to the front of the frame than to the back of the frame for removeably coupling with a container, the container for containing harvested berries.

19. The berry picking kit of claim 16, wherein the frame has a length of 36 inches and a width of 18 inches.

20. The berry picking kit of claim 16, wherein the fabric comprises flannel.
